(19) United States
(12) Patent Application Publication
(10) Pub. No.: US 2026/0035588 A1
(43) Pub. Date: Feb. 5, 2026

(54) PUMPABLE EXPANDABLE SEALANT USEFUL IN VEHICLES

(71) Applicant: Henkel AG & Co. KGaA, Duesseldorf (DE)

(72) Inventors: Neil R. Wilson, Lake Orion, MI (US); Hiroko Okuno Mattice, Rochester, MI (US); Girdhari Kumar, Troy, MI (US); Kristen Louise Johns, Sterling Heights, MI (US); Alexandria Sarah Corbin, Chesterfield, MI (US); Paul D. Zeits, Rochester, MI (US); Gail M. Henning, Troy, MI (US); Pravin V. Patel, Canton, MI (US)

(21) Appl. No.: 19/356,473

(22) Filed: Oct. 13, 2025

Related U.S. Application Data
(63) Continuation of application No. PCT/US2024/023986, filed on Apr. 11, 2024.
(60) Provisional application No. 63/497,333, filed on Apr. 20, 2023.

(51) Int. Cl. C09D 109/06; C09D 7/62; C09D 7/65

(52) U.S. Cl. CPC C09D 109/06; C09D 7/62; C09D 7/65

(57) ABSTRACT

Disclosed are pumpable expandable compositions useful in sealing cavities in vehicles, and methods of applying the compositions which significantly improve vertical and inverted sag resistance without detracting from performance; compositions of the invention and methods of applying them provide greater versatility in sealing larger gaps and cavities due to improved expansion height.

### TECHNICAL FIELD

The disclosure is directed to pumpable thermally expandible sealants useful in filing and sealing vehicle cavities.

### BACKGROUND

Extruded tapes or injection molded articles are commonly used as cavity fillers, such as so-called pillar fillers that are placed in B-pillar roof supports of vehicles. Both products are manually applied to the vehicles, which tends to be labor intensive. Such products also require customers to invest in expensive tooling, packaging and storage space for every part geometry, which increases complexity in administration and logistics. Also, cycle time is long due to many steps required to make the parts. Thus, there is a need for simpler cavity fillers and sealants that provide performance similar to conventional parts and tapes, but overcome at least some of the drawbacks of these products.

Significant customer savings can be achieved using a pumpable, expandable sealant versus tapes or injection molding. Pumpable expandable sealant can be deposited using an automated application method and apparatus, no extrusion or injection molding is needed, and standard pumping equipment may be used for application. Pumpable expandable sealant will reduce complexity of administration and logistics, and reduce warehousing space for storage. Material can be supplied in pails or drums thereby reducing packaging versus multiple parts and packaging containers for various sizes of 2D tapes and 3D parts.

Challenges remain in providing pumpable expandable sealant to replace 2D tapes and 3D parts. For example, a pumpable expandable uncured sealant must not flow out of position for up to 2, 4, 6, 8, 10 or 12 weeks after application to a metal surface, such as a metal vehicle body. Some pumpable materials have caused concerns regarding sag for pumpable material applied in a vertical and/or inverted position when the bead thickness is greater than 10 to 20 mm. U.S. Pat. No. 10,836,881 B2 sought to address sag problems by including epoxy resin and 25 to 35 wt. % filler. The material containing the epoxy filler combination has sealing performance drawbacks due to increased rigidity. After the material expands, it shrinks curing cool down. If cured material is rigid, there can be holes between the material and the top panel due to the shrinkage and low flexibility. Other paste type heat foamable materials containing large amounts of inorganic filler have similar performance issues due to becoming rigid and inflexible after cure and cool down. JP3017571B2 describes a paste type heat expandible pillar filler for automatic application that contains amounts of liquid rubber causing difficulty in retaining gas generated by blowing agents which can lead to foam collapse and sealing failure. US20130280451A1 discloses a paste-like thermally expandable filler comprising: an uncrosslinked rubber; a quinone-based vulcanizing agent; and a foaming agent. The material contains a quinone-based vulcanizing agent that works as a self-skinning agent to hold the shape of the bead to prevent sag, but has the drawback of preventing wetting between the bead surface and the metal panel contacted during cure preventing sealing.

Thus, there is a need for pumpable cavity fillers and sealants that provide performance similar to conventional parts and tapes, but overcome at least some of the drawbacks of known pumpable or paste-like products, including sag resistance coupled with expansion and adhesion for bridging and/or filling cavities.

### SUMMARY OF THE INVENTION

The disclosure is directed to new compositions of matter, including pumpable thermally expandable sealant composition that expand when heated and adhere to cavity surfaces thereby sealing the cavity. The pumpable thermally expandable sealant compositions of the invention exhibit improvements in sag resistance coupled with expansion and adhesion. Also provided are assemblies having improved sealing of cavities therein achieved by applying the pumpable thermally expandable sealant composition to one or more surfaces of a cavity or cavity portion to be sealed and curing the pumpable thermally expandable sealant composition, and methods of making these liquid epoxy-based adhesives, methods of sealing articles of manufacture. Various embodiments of the invention are described throughout this disclosure including:

Embodiment 1. A pumpable thermally expandable sealant composition comprising or consisting essentially of or consisting of: synthetic rubber, preferably styrene butadiene rubber (SBR), a PVC homopolymer or copolymer; a wax thixotropic agent; a blowing agent; a liquid rubber optionally functionalized; a vulcanizing agent, a vulcanization accelerator; and one or more fillers.

Embodiment 1a. A pumpable thermally expandable sealant composition comprising or consisting essentially of or consisting of: SBR rubber; a PVC homopolymer/copolymer and/or acrylic resin powder having a Tg in a range of 50 to 120° C.; an amide wax thixotropic agent having a melting point range from 80° C. to 150° C.; a blowing agent; functionalized liquid rubber sulfur vulcanizing agent; one or more vulcanization accelerators, and at least one filler.

Embodiment 2. The composition of any one of the preceding Embodiments, wherein the wax thixotropic agent comprises an amide wax and optionally fumed silica, preferably hydrophilic fumed silica.

Embodiment 3. The composition of any one of the preceding Embodiments, wherein the PVC polymer is a homopolymer present in an amount sufficient to thicken the composition increasing post-application sag resistance while retaining pumpable viscosity during application.

Embodiment 4. The composition of any one of the preceding Embodiments, wherein the liquid rubber is functionalized, preferably with maleic anhydride.

Embodiment 5. The composition of any one of the preceding Embodiments, wherein the composition comprises less than 5 wt. % epoxy resin.

Embodiment 6. The composition of any one of the preceding Embodiments, further comprising a peroxide curing agent.

Embodiment 7. The composition of any one of the preceding Embodiments, further comprising a co-crosslink agent comprising a poly (meth)acrylate functional cross-linking agent, preferably having a plurality of sites of unsaturation.

Embodiment 8. The composition of Embodiment 7, wherein the co-crosslink agent comprises a polyacrylate functional cross-linking agent having at least four sites of unsaturation.

Embodiment 9. The composition of any one of the preceding Embodiments, further comprising plasticizer, preferably in an amount of 15-55 wt. %.

Embodiment 10. The composition of any one of the preceding Embodiments, further comprising an antioxidant.

Embodiment 11. The composition of Embodiment 1 or 1a comprising or consisting essentially of or consisting of:
a. SBR Rubber present in an amount ranging from 5-30 wt. % preferably 7-20 wt. %, most preferably at least 12, 13, 14 or 15 wt. %
b. PVC homopolymer/copolymer and/or acrylic resin powder preferably having a Tg in a range of 50° C. to 120° C. present in an amount ranging from 2-35 wt. %, preferably 5-30 wt. %.
c. Amide wax thixotropic agent preferably having a melting point range from 80 C to 150° C., present in an amount ranging from 0.25 wt. % to 5 wt. %, preferably about 0.5 to 6 wt. %;
d. Blowing Agent (OBSH preferred but may also use ADCA with an accelerator package) present in an amount ranging from 0.5 wt. % to about 15 wt. %, preferably 1.0 wt. % to 10 wt. %
e. Liquid rubber, optionally functionalized present in an amount ranging from 0.25-20 wt. %, preferably 0.5% to 10 wt. %;
f. Sulfur, present in an amount of about 0.1 wt. % to about 4 wt. %, preferably 0.2 wt. % to 2 wt. %;
g. Sulfur crosslink accelerators, present in an amount ranging from 0.25-about 4 wt. %, preferably about 0.5 wt. % to 5 wt. %;
h. Plasticizer present in an amount of about 15-55 wt. %, preferably 20-50 wt. %;
i. Filler present in an amount of about 1 to 25 wt. %, preferably 1 to 20 wt. %;
j. Antioxidant, preferably having a melting point greater than 100, 110, 120, 130, 140 or 150° C., present in an amount ranging from 0.25-1.25 wt. % preferably 0.5-1.5 wt. %
k. Optionally comprising one or more of fumed silica, a peroxide curing agent; and a co-crosslinking agent, which may each independently be present in an amount of up to 2.0 wt. %; wherein all of the foregoing amounts are based upon total amount of the composition.

Embodiment 12. The composition of Embodiment 11, wherein functionalized liquid rubber, is functionalized with anhydride, epoxy or acid functional groups, preferably 0.1 to 30% maleic anhydride functional groups, said liquid rubber being present in an amount ranging from 0.25-20 wt. %, preferably 0.5% to 10 wt. %.

Embodiment 13. The composition of Embodiment 11 or 12, wherein the peroxide curing agent and the co-crosslinking agent are present in an amount of 0.1 to 2 wt. %, the liquid rubber is functionalized with maleic anhydride and the composition is curable in about 15-20 minutes at a metal temperature of 140° C.

Embodiment 14. A method for producing an article, the method comprising:
a) applying the pumpable thermally expandable sealant composition according to any of the foregoing Embodiments into a gap or cavity in an article, preferably the article comprises metal surfaces; and
b) heating the article comprising the pumpable thermally expandable sealant composition to a temperature above an activation temperature of the blowing agent expanding the sealant to form an expanded material within the gap or cavity in the article thereby producing a reinforced and/or sealed section of the gap or cavity in the article, preferably expanding from the surface the material was applied to across to the other side of the cavity to be sealed, reaching opposing metal surfaces.

Embodiment 15. The method of Embodiment 14, wherein the article is a vehicle part, preferably an aerospace, automotive, marine, or construction vehicle part.

Embodiment 16. An article of manufacture comprising: a part having a metal surface, a composite material surface or a combination of said surfaces; and deposited on a portion of said surfaces, an uncured, heat expandable sealant comprising: SBR rubber; a PVC homopolymer/copolymer and/or acrylic resin; an amide wax; a blowing agent; a liquid rubber functionalized with maleic anhydride, epoxy or acid function groups; vulcanizing agent, comprising sulfur; one or more vulcanization accelerators, and at least one filler; wherein the sealant is curable within a target bake condition of 15 minutes at 140° C. metal temperature to exhibit a cohesive failure mode of at least 80%.

The article of manufacture of Embodiment 16, wherein the uncured, heat expandable sealant deposited on said surfaces exhibits less than 10% increase in height after a 24 hour inverted dwell time.

The article of manufacture of Embodiment 16, wherein the uncured, heat expandable sealant is capable of a vertical height expansion, at 15 minutes bake at 140° C., of greater than 8 times (8×) the uncured heat expandable sealant as deposited.

The article of manufacture of Embodiment 16, wherein the article is a vehicle part, preferably an aerospace, automotive, marine, or construction vehicle part.

### BRIEF DESCRIPTION OF THE DRAWINGS

FIG. 1 shows a top view photograph of a CRS panel having an uncured expandable sealant composition of the invention deposited on a central portion of the surface thereof.

FIG. 2 shows a top view photograph of the CRS panel of FIG. 1 having the uncured expandable sealant composition of the invention deposited on a central portion of the surface and spacer blocks positioned on uncoated portions of the CRS surface at each corner of the panel.

FIG. 3 shows a top view photograph of an assembly comprising the CRS panel of FIG. 2 (not shown) and a second CRS panel positioned over the FIG. 2 CRS panel and supported on the spacer blocks of FIG. 2. The assembly further comprises clamps securing the panels onto the spacers at each corner holding the assembly together.

FIG. 4 shows a side view photograph of the assembly of FIG. 3 prior to baking of the expandable sealant composition of the invention, showing a gap between the CRS panels.

FIG. 5 shows a side view photograph of the assembly of FIG. 3 after to baking of the expandable sealant composition of the invention, showing foamed sealant filling portions of the gap between the CRS panels.

### DETAILED DESCRIPTION OF EMBODIMENTS OF THE INVENTION

The presently disclosed inventive subject matter may be understood more readily by reference to the following detailed description taken in connection with the accompanying figures and examples, which form a part of this disclosure. It is to be understood that these inventions are not limited to the specific components, methods, or parameters described and/or shown herein, and that the terminology used herein is for the purpose of describing particular embodiments by way of example only and is not intended to be limiting of the claimed inventions.

The disclosure provides pumpable thermally expandable sealant composition comprising or consisting essentially of or consisting of: synthetic rubber, preferably styrene butadiene rubber (SBR), a polyvinyl homopolymer or copolymer; a wax thixotropic agent; a blowing agent; a liquid rubber optionally functionalized; a vulcanizing agent, a vulcanization accelerator; and one or more fillers.

In some embodiments, the pumpable thermally expandable sealant composition may comprise, consist essentially of or consist of SBR rubber; a PVC homopolymer/copolymer and/or acrylic resin powder have a Tg in a range of 50 to 120° C.; an amide wax thixotropic agent having a melting point range from 80° C. to 150° C.; blowing agent; liquid rubber functionalized with maleic anhydride, epoxy or acid function groups; vulcanizing agent, preferably sulfur; one or more vulcanization accelerators, e.g. octadecanoic acid, tetramethylthiuram disulfide (TMTD), Zinc Oxide; and at least one filler, such as carbon black, calcium carbonate, magnesium silicate; optionally additional additives may include silica, fumed silica; a secondary peroxide cure agent, such as dicumyl peroxide and/or a co-crosslink agent, e.g. a poly (meth)acrylate functional cross-linking agent having 2, 3, 4, 5, or more sites of unsaturation; an antioxidant, such as 4,4′-Methylenebis(2,6-di-tert-butylphenol); plasticizer, i.e. diisononyl phthalate, petroleum distillate, extender oil, e.g. naphthenic oil. In a preferred embodiment, the pumpable thermally expandable sealant composition contains less than in increasing order of preference, 5, 4.5, 4, 3.5, 3, 2.5, 2, 1.5, 1, 0.5 or 0.1 wt. % epoxy resin.

A necessary component of the pumpable thermally expandable sealant composition contains Component a. of rubber, in particular a synthetic rubber and preferably a partially crosslinked synthetic rubber. Exemplarily partially crosslinked rubbers for use in the inventive filler composition are diene rubbers, such as, e.g., acrylonitrile-isoprene copolymer rubber (NIR), acrylonitrile-butadiene copolymer rubber (NBR), styrene-butadiene copolymer rubber (SBR), a butadiene rubber (BR) and isoprene rubber (IR). The crosslinking may be the result of the addition of a crosslinking agent, such as divinyl benzene or sulfur. The addition of a rubber provides the advantages of improved rheological properties, sag resistance, wash-off resistance and a higher volume expansion of the resulting filler composition.

The pumpable thermally expandable sealant composition contains Component b. of polyvinylchloride (PVC) resin which may be a polyvinylchloride homopolymer or a copolymer, optionally acrylic resin powder may be used instead of or in combination with the PVC. Preferably Component b materials have a Tg in a range of 50° C. to 120° C. In some embodiments the PVC is a homopolymer such as the Formulon brand of including homopolymers from Formosa.

The pumpable thermally expandable sealant composition contains Component c. of a thixotropic agent comprising wax, which can be synthetic, petrochemical based, of natural wax preferably having a melting point range from 80° C. to 150° C. Amide wax is preferred, and may be used alone or combined with the other waxes disclosed provided that the objects of the invention are still met.

Another necessary component of the pumpable thermally expandable sealant composition is Component d. of blowing agent, which is responsible for expansion of the sealant composition when baked. Any substance may be used which decomposes by heating to generate a gas. A variety of known blowing agents may be used provided that they do not interfere with performance of the invention such as sag resistance and low bake cure, including so called-endothermic blowing agents combining an organic acid, e.g. citric acid and carbonate, such as sodium bicarbonate. OBSH is preferred but ADCA may also be used with an accelerator package. Blowing agent must be stable enough in the composition to avoid premature foaming during bake which can lead to foam collapse before full cure is achieved.

Desirably, the pumpable thermally expandable sealant composition contains Component e. of liquid rubber, optionally functionalized with anhydride, epoxy or acid functional groups, preferably 0.1 to 30% maleic anhydride functional groups, said liquid rubber being present in an amount ranging from 0.25-20 wt. %, preferably 0.5% to 10 wt. %

A cure package comprising sulfur and sulfur accelerators, as is known in the art is preferably used for primary curing of the composition. Additional reactive or cross-linking components as disclosed herein include peroxide secondary curing agent and co-crosslinkers comprising compositions having two or more sites of ethylenic unsaturation, preferably alpha-beta unsaturation. Some co-cross-linkers comprise a plurality of these terminal sites of unsaturation, including 3, 4, 5, or more sites of unsaturation. The combination of different curatives permits enhanced control of the expansion.

The pumpable expandable sealant compositions described herein provide one or more of the significant improvements discussed above. The invention discloses a method that significantly improves the vertical and inverted sag resistance without impacting the expansion performance, flexibility and adhesion after cool down. In some embodiments, the invention can allow for a greater number of sealing applications which require larger gaps to be filled due to improvements in expansion height. Another aspect of this invention relates to a formulation that can expand and cure within a target bake condition of 15 minutes at 140° C. metal temperature while maintaining a cohesive failure mode of at least 809, 85, 90, 95, 96, 97, 98, 99 or even 100%. Another aspect of this invention relates to the humidity resistance properties that allow for high humidity exposure of the uncured composition without impacting vertical expansion performance.

Desirably, pumpable expandable sealant compositions of the invention seal the gap completely, by expanding from the panel the material was applied to (e.g. bottom panel) to the other side of the cavity to be sealed, reaching opposing metal surfaces and adhere thereto (e.g. top panel) before the composition fully cures, preferably before 10, 20, 30, 40, 50, 60 or 70% curing.

In some embodiments, pumpable expandable sealant compositions of the invention provide low temperature expansion, for example expansion at temperatures of as low as 125, 130, 135, or 140° C. Preferred embodiments meet expansion requirements of 15 minute bake at 140° C. while also meeting cohesive failure mode on CRS, HDG, EZG, Aluminum and E-coated metal panels. In some embodiments, vertical height expansion at 15 minutes bake at 140° C. is greater than 8 times (8×) the originally deposited uncured composition film height.

Desirably pumpable expandable sealant compositions of the invention contain a sag resistance package that does not reduce the vertical expansion height performance. By incorporating a natural, petroleum-based or synthetic wax, preferably an amide wax, optionally with added fumed silica, preferably hydrophilic fumed silica, into the uncured sealant compositions, the inventors found that they were able to prevent a 10 mm height ½ moon-shaped bead, applied to a metal panel, from sagging more than 10% after aging for a 1 day or more when placed in an inverted position. While other thickening agents may prevent sag, they also increase resistance to expansion during the baking process. This restricts expansion and wet out properties of expandable sealers. The instant invention uses a combination of wax having a melting point greater than 70, 75, 80, 85 90, 95, 100, 110, or 120° C. and lower than in increasing order of preference, 200, 180, 160, 150, 140, 135 or 130° C. In a preferred embodiment, in the melted state, rheology of the expandible composition remains low enough to provide flexibility and expansion height during the gassing phase which occurs in a range of about 130-135° C. and above.

In some embodiments, pumpable expandable sealant compositions of the invention further comprise organic resins, such as polyvinylchloride (PVC) polymers and/or PVC copolymers and/or (meth)acrylate polymers and/or copolymers useful in thickening the composition at temperatures above the Tg point of the PVC or (meth)acrylate. Presence of the organic oligomers and/or polymers is useful in further controlling sag properties at temperatures where the wax is fully melted and no longer contributes as much resistance to sag. The combination of amide wax and the PVC and/or acrylate materials provides a synergistic balance of viscosity as temperature increases so that sag resistance is maintained.

In some embodiments, pumpable expandable sealant compositions of the invention provide low solids formulations which reduce mass of the cured product and contribute to vehicle lightweighting. Low solids formulations may also be useful in maximizing the percent elongation after cure preventing adhesion failure during cooldown as well as optionally reducing cost per application. In some embodiments, density of the uncured pumpable sealant composition may be less than 1.25 g/cm3, in preferred embodiments the solids level may be as low as, in increasing order of preference 0.90, 0.95, 1.0, 1.10, 1.12, 1.13, 1.14 or 1.15 g/cm3, and up to in increasing order of preference 1.30, 1.28, 1.25, 1.24, 1.22, 1.20, 1.19, 1.18, 1.17 or 1.16 g/cm3.

In some embodiments, pumpable expandable sealant compositions of the invention further comprise a high temperature resistance package providing increased stability. The high temperature resistance package includes a high melting point antioxidant preferably present in amounts greater than 0.5 wt. %. of total mass of the composition. High melting point will be understood to mean a MP greater than the activation temperature of any peroxide or other free-radical generator used in the formulation, if present. Typical range may be about 140° C. to about 200° C. depending on bake temperature used in the oven. In preferred embodiments the high melting point antioxidant is present in amounts of at last in increasing order of preference 0.40, 0.44, 0.46, 0.48, 0.50, 0.52, 0.53 or 0.54 wt. %, and upper limits in increasing order of preference of 1.4, 1.3, 1.2, 1.1, 1.0, 0.95, 0.9, 0.85, 0.8, 0.75, 0.7, 0.65, 0.6 or 0.55 wt. %. In some embodiments, the preferred level is about 0.8 wt. % to 1.5 wt. %, but may be higher, which is not preferred for economic reasons. The package may stabilize the foam vertical height expansion performance to temperatures up to 215° C. for 20 minutes exposure without a loss in performance in adhesion and expansion

Application methods for applying pumpable expandable sealant compositions of the invention may include conventional methods such as bead or round tip applications, but depending on processing, conventional methods may not achieve all benefits of the invention. In preferred embodiments, to obtain most benefits of the invention, application desirably is by thin film spray or extrusion in place. Preferably the application method results in a film deposition of 0.5 mm to 3 mm thick and about 10 to 30 mm wide or wider up to the spray film apparatus performance limits for consistent thickness film deposition. These widths are significantly greater area at less depth versus a typical bead application. The benefit to applying a thin film that has a wide width is a more sag resistance and uniform expansion across a vertical gap. Another benefit of thin films deposition is less material usage versus a bead or round tip extrusion application and less added vehicular mass.

This disclosure embraces all articles of manufacturing comprising any of the (pre- or partially cured) expandable sealant compositions of the invention composition, as applied thereto (but not fully cured), as well as any cured expanded sealant layers adhered thereto. In certain embodiments, the article of manufacturing may be used in transportation industries, such as aerospace, automotive, marine, and construction vehicle manufacture using heat curing methods. In a preferred embodiment, expandable sealant compositions may be used in vehicle parts or components where noise, vibration, harshness resistance is desirable. The surfaces to be sealed may be metal surfaces, composite materials parts or a combination thereof useful for example an automobile or a part thereof.

### Terms and Abbreviations

In the present disclosure the singular forms “a,” “an,” and “the” include the plural reference, and reference to a particular numerical value includes at least that particular value, unless the context clearly indicates otherwise. Thus, e.g., a reference to “a corrosion inhibitor” is a reference to one or more of such corrosion inhibitors and equivalents thereof known to those skilled in the art, and so forth. Furthermore, when indicating that a certain element “may be” X, Y, or Z, it is not intended by such usage to exclude in all instances other choices for the element.

When a value is expressed as an approximation by use of the descriptor “about,” it will be understood that the particular value forms another embodiment. In general, the use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

The transitional terms “comprising,” “consisting essentially of,” and “consisting” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

When values are expressed as approximations, by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. In some embodiments, “about X” (where X is a numerical value) refers to ±10% of the recited value, inclusive. For example, the phrase “about 8” can refer to a value of 7.2 to 8.8, inclusive. This value may include “exactly 8”. Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.”

For a variety of reasons, it is preferred that inventions (e.g. compositions and, uncured adhesive, precured adhesive and cured adhesive, methods and articles of manufacture) disclosed herein may be made in the absence of certain ingredients, and, i.e., be free of certain materials whether added or generated in situ other than minor amounts of contaminants, or may be free or substantially free from many ingredients used in compositions for ingredients for similar purposes in the prior art. Specifically, it is increasingly preferred in the order given, independently for each preferably minimized ingredient listed below, that at least some embodiments according to the invention contain no more than 1.0, 0.5, 0.35, 0.10, 0.08, 0.04, 0.02, 0.01, 0.001, or 0.0002 percent, more preferably said numerical values in grams per liter, more preferably said numerical values in ppm, of each of the following constituents: epoxy resin, copper, oxidizing agents such as peroxyacids, permanganate, perchlorate, chlorate, chlorite, hypochlorite, perborate, hexavalent chromium, trivalent chromium, sulfuric acid and sulfate, nitric acid and nitrate ions; as well as fluorine, formaldehyde, formamide, hydroxylamines, cyanides, cyanates; rare earth metals; boron, e.g. borax, borate; strontium; free halogen ions, e.g., fluoride, chloride, bromide or iodide; and/or epoxy curing accelerator comprising unsubstituted urea, an imidazole, phosphonium ionic liquid, unblocked tertiary amine or blocked tertiary amine active at ambient temperature, polyamine salts of polyhydric phenols, or a combination thereof.

The present invention is further defined in the following Examples. It should be understood that these examples, while indicating preferred embodiments of the invention, are given by way of illustration only, and should not be construed as limiting the appended claims From the above discussion and these examples, one skilled in the art can ascertain the essential characteristics of this invention, and without departing from the spirit and scope thereof, can make various changes and modifications of the invention to adapt it to various usages and conditions.

### Examples

Test compositions were made as follows unless indicated otherwise: A master batch comprising 100 pbw (parts by weight), SBR rubber, 75 pbw carbon black and 50 pbw naphthenic oil was made by mechanically mixing the components until uniformly combined. Thereafter, the remaining components for each example were blended into a quantity of the master batch indicated as indicated in tables.

### Performance Testing

Expansion was tested to determine the vertical height change of heat expandable sealers. This test method used was based on the Toyota test method TSK 6527G (6.3.5 Expansion ratio) and TSK 6529G (5.6 Expansion rate). Materials used were: 150×75×0.8 mm oiled CRS panels, panels for drawing the uncured composition onto the CRS panels, 9 mm and 13 mm spacer blocks, 1.5 mm spacers and 1″ wide masking tape.

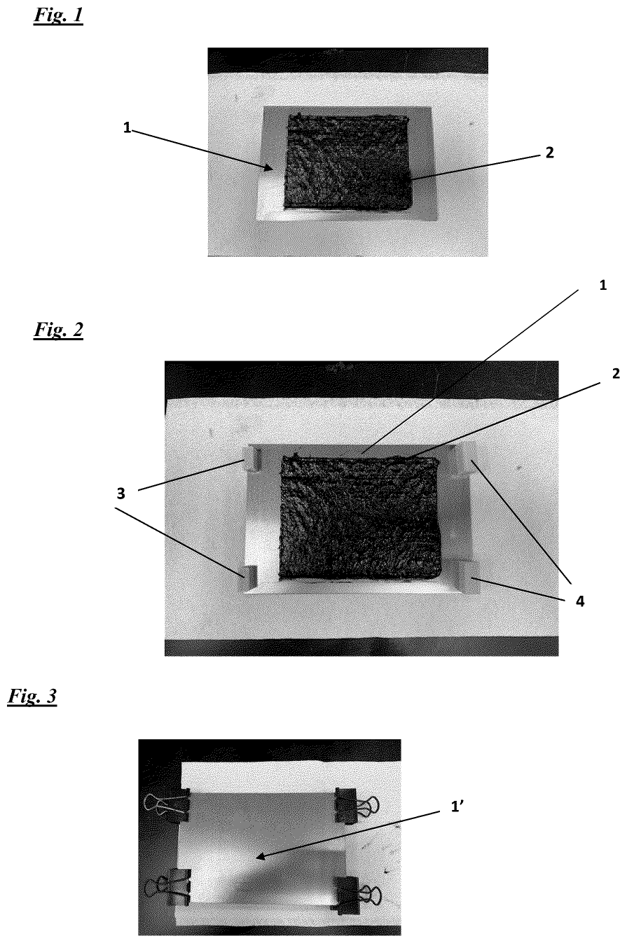

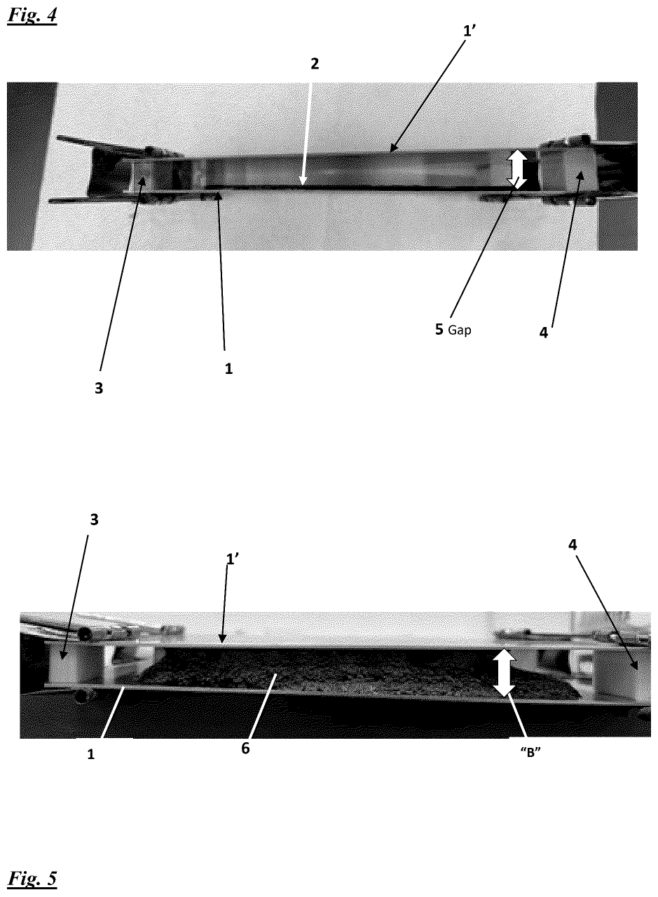

The following procedure was used in all examples unless otherwise indicated: Apply uncured sealer composition onto an oiled CRS panel (1) covering a surface area of approximately 100 mm×75 mm with a draw bar or spacer using known methods, such as masking, to leave uncoated panel surface area surrounding the cast composition, see FIG. 1. Cast the test composition at a 45-degree angle across the panel and cast again at a 45-degree angle in the opposite direction. Inspect the cast layer surface for any voids. If voids are present, cast over the top surface to eliminate voids. Carefully, remove tape or other masking. Record the initial height “M” of the uncured sealant composition (2). Unless otherwise indicated, all Examples had an uncured sealer composition (2) cast on the oiled CRS panels (1) at an initial height “M” of 1.62 mm.

Place a pair of 9 mm spacer blocks (3) on adjacent corners of the oiled CRS panel (1) surface bearing the uncured sealer composition (2), and a second pair of 13 mm spacer blocks (4) on the opposite corners of said surface, see FIG. 2. Apply a top oiled CRS panel (1′) approximately 100 mm width×75 mm×0.8 mm onto the spacers and clamp the panels onto the spacers at each corner. Ensure the panel (1′) is lying flat across with a gap (5) starting at 9 mm and increasing to 13 mm, see FIGS. 3 & 4. Bake the CRS panel uncured sealer assembly sample in a forced air circulating type oven for the time and peak metal temperature as specified in the Examples. Allow the sample to cool to room temperature. Determine the location where the expanded cured sealant (6) is uniformly in contact with the top CRS panel (1′). Measure the maximum gap height (B) at this location which corresponds to Expanded thickness “B”. Vertical expansion of the sealer was determined using the following formula:

$$Expansion ( multiplies of M ) = B mm / M mm$$

In one Example, Expanded thickness B was measured as 11.51 mm. Expansion of this Example was 11.51 mm/1.62 mm−=7.1×Expansion.

### Examples 1 and 2

TABLE 1

| | Example | Example |
|---|---|---|
| Component Amount (g) | 1 | 2 |
| SBR Masterbatch | 31.5 | 29.6 |
| Hydrotreated Heavy Naphthenic Distillate | 11.70 | 11.9 |
| Proprietary Zinc/Aluminum Complex | 3.00 | 3.00 |
| 4,4′-Methylenebis(2,6-Di-Tert-Butylphenol) | 0.80 | 0.80 |
| Octadecanoic Acid | 0.45 | 0.45 |
| Maleic anhydride adduct of 1,4-cis polybutadiene | 2.75 | 3.06 |
| 4,4′-Oxybis(benzenesulfonyl hydrazide) OBSH | 5.30 | 5.30 |
| TMTD—Tetramethylthiuram Disulfide | 0.90 | 0.88 |
| Zinc Oxide | 2.80 | 2.80 |
| Dipentaerythritol Pentaacrylate | 0.30 | 0.30 |
| Dicumyl Peroxide 40% Active | 1.00 | 0.98 |
| 793 Conditioned Superfine Rm Sulfur | 0.40 | 0.44 |
| Accelerator MBTS Powder - Dibenzothiazyl | 0.80 | 0.65 |
| Disulfide | | |
| Hydrophilic Fumed Silica | 1.50 | 1.37 |
| Amide wax | 1.1 | 1.1 |
| Polyvinyl chloride homopolymer | 8.1 | 8.1 |
| Diisononyl phthalate | 27.6 | 29.27 |

Example 1 was tested as described herein for vertical expansion.
Results Target Bake: 11.0 times vertical expansion, starting film thickness 1.5 mm, maximum gap bridged after 171° C. bake for 20 minutes was 16.5 mm.
Vertical expansion Results Low Bake: 10.4 times vertical expansion, starting film thickness 1.42 mm, maximum gap bridged after 171° C. bake for 20 minutes was 14.63 mm.
Uncured pumpable sealant composition was tested for:
a. Viscosity at 23° C., shear rate at 1/20 sec. during a shear ramp. Result=753 Pa-s
b. Inverted Sag test: 10 mm Height×20 mm wide×100 mm long ½ bead cast onto an oiled CRS panel. Results: 24 hour inverted dwell=less than 10% increase in bead height.

Example 2 was tested as described herein for vertical expansion.
Results Target Bake: 11.2 times vertical expansion, starting film thickness 1.6 mm, maximum gap bridged after 171° C. bake for 20 minutes metal temperature was 18.9 mm maximum gap sealed.
Vertical expansion Results Low Bake: 9.9 times vertical expansion, starting film thickness 1.5 mm, maximum gap bridged after 140° C. bake for 15 minutes metal temperature was 14.8 mm. This demonstrates the performance of this formula to meet low temperature expansion performance.
Uncured pumpable sealant composition was tested for:
a. Viscosity at 23° C., shear rate at 1/20 sec. during a shear ramp. Result=679 Pa-s
b. Inverted Sag test conditions as described for Example 1.
   Sag Results: 24 hour inverted dwell=less than 10% increase in bead height.

### Examples 4 and 5 and Comparative Example 1

TABLE 2

| | Comp. Ex. 1 | Ex. 4 | Ex. 5 |
|---|---|---|---|
| Component Amount | (g) | (%) | (%) |
| SBR Masterbatch | 29.239 | 29.0% | 29.0% |
| Hydrotreated Heavy Naphthenic | 14.260 | 14.1% | 14.1% |
| Distillate | | | |
| Magnesium Silicate | 1.999 | 2.0% | 2.0% |
| 4,4′-Methylenebis(2,6-Di-Tert- | 0.941 | 0.9% | 0.9% |
| Butylphenol) | | | |
| Octadecanoic Acid | 0.460 | 0.5% | 0.5% |
| Maleic anhydride adduct of 1,4-cis | 2.268 | 2.2% | 2.3% |
| polybutadiene | | | |
| 4,4′-Oxybis(benzenesulfonyl hydrazide) | 3.721 | 3.7% | 3.7% |
| TMTD—Tetramethylthiuram Disulfide | 0.915 | 0.9% | 0.9% |
| Zinc Oxide | 3.014 | 3.0% | 3.0% |
| Dipentaerythritol Pentaacrylate | 0.298 | 0.3% | 0.3% |
| Dicumyl Peroxide 40% Active | 1.005 | 1.0% | 1.0% |
| 793 Conditioned Superfine Rm Sulfur | 0.331 | 0.3% | 0.3% |
| Accelerator- Dibenzothiazyl Disulfide | 0.941 | 0.9% | 0.9% |
| Fumed silicone dioxide treated | 1.008 | 1.0% | 1.0% |
| Polyvinyl chloride Homopolymer | 8.076 | 8.0% | 8.0% |
| Diisononyl phthalate | 31.524 | 31.2% | 31.3% |
| Organophilic phyllosilicates | | 0.9% | |
| Amide wax | | | 0.8% |

TABLE 3

| | Comp. Ex. 1 | | |
|---|---|---|---|
| Results: | (g) | Ex. 4 | Ex. 5 |
| Inverted Sag Test - | Failed, sagged | Passed, <10% | Passed, <10% |
| 10 mm height, 20 mm | off panel in | increase in | increase in |
| wide, 100 mm long ½ | 24 hours | height from | height from |
| bead cast, placed | | sag | sag |
| inverted for 24 hours | | | |
| Vertical Expansion | 8.1 times | 3.33 times | 7.8 times |
| Height Rate (20 | | | |
| minute bake at | | | |
| 171° C.) | | | |

Example 5 demonstrated the improvement in sag resistance using amide wax without significant impact on the vertical expansion. The use of organophilic phyllosilicates in Example 4 showed a reduction in vertical expansion performance, but maintained sag resistance, indicating that increasing filler, e.g. Fumed Silicone Dioxide or other fillers, amounts improved the inverted sag resistance, but the vertical expansion performance was lowered.

The skilled artisan will understand that the foregoing Examples are merely embodiments illustrating the inventions components and performance. They are in no way intended to limit the invention to the exemplary embodiments.

1. A pumpable thermally expandable sealant composition comprising: synthetic rubber, a PVC homopolymer or copolymer; a wax thixotropic agent; a blowing agent; a liquid rubber optionally functionalized; a vulcanizing agent, a vulcanization accelerator; and one or more fillers.

2. The composition of claim 1, wherein the wax thixotropic agent comprises an amide wax and the composition further comprises fumed silica optionally comprising hydrophilic fumed silica.

3. The composition of claim 2, wherein the PVC polymer is a homopolymer present in an amount sufficient to thicken the composition thereby increasing post-application sag resistance while retaining pumpable viscosity during application.

4. The composition of claim 3 wherein the liquid rubber is functionalized with maleic anhydride.

5. The composition of claim 1, wherein the composition comprises less than 5 wt. % epoxy resin.

6. The composition of claim 1, further comprising one or more of a peroxide curing agent; an antioxidant; and plasticizer.

7. The composition of claim 1, further comprising a co-crosslink agent comprising a poly (meth)acrylate functional cross-linking agent having a plurality of sites of unsaturation.

8. The composition of claim 7, wherein the co-crosslink agent comprises a polyacrylate functional cross-linking agent having at least four sites of unsaturation.

9. The composition of claim 6, wherein the plasticizer is present in an amount of 15-55 wt. %.

10. The composition of claim 1, wherein the synthetic rubber comprises SBR rubber; the PVC homopolymer and/or copolymer has a Tg in a range of 50 to 120° C.; the wax thixotropic agent comprises an amide wax having a melting point range from 80° C. to 150° C.; the liquid rubber is functionalized with maleic anhydride, epoxy or acid function groups; the vulcanizing agent, comprises sulfur.

11. A pumpable thermally expandible sealant composition comprising:
a. SBR Rubber present in an amount ranging from 5-30 wt. %;
b. PVC homopolymer/copolymer and/or Acrylic resin powder optionally having a Tg in a range of 50° C. to 120° C. present in an amount ranging from 2-35 wt. %;
c. Amide wax thixotropic agent optionally having a melting point range from 80 C to 150° C., present in an amount ranging from 0.25 wt. % to 5 wt. %;
d. Blowing Agent present in an amount ranging from 0.5 wt. % to about 15 wt. %;
e. Liquid rubber, optionally functionalized with anhydride, epoxy and/or acid functional groups, said liquid rubber being present in an amount ranging from 0.25-20 wt. %;
f. Sulfur, present in an amount of about 0.1 wt. % to about 4 wt. %;
g. Sulfur crosslink accelerators, present in an amount ranging from 0.25-about 4 wt. %;
h. Plasticizer present in an amount of about 15-55 wt. %;
i. Filler present in an amount of about 1 to 25 wt. %;
j. Antioxidant, optionally having a melting point greater than 100° C., present in an amount ranging from 0.25-1.25 wt. %;
k. Optionally comprising one or more of fumed silica, a peroxide curing agent; and a co-crosslinking agent, which may each independently be present in an amount of up to 2.0 wt. %;
wherein all amounts are based upon a total amount of the composition.

12. The composition of claim 11, wherein:
a. the SBR Rubber is present in an amount in a range of 12-20 wt. %;
b. the PVC homopolymer/copolymer and/or Acrylic resin powder is present in an amount in a range of 5-30 wt. %;
c. the amide wax thixotropic agent having a melting point in range from 80 C to 150° C., is present in an amount ranging from about 0.5 wt. % to about 6 wt. %;
d. the blowing agent is present in an amount ranging from 1.0 wt. % to 10 wt. %;
e. the liquid rubber, functionalized with anhydride, epoxy and/or acid functional groups, is present in an amount ranging from 0.5% to 10 wt. %;
f. the sulfur, is present in an amount of about 0.2 wt. % to about 2 wt. %;
g. the sulfur crosslink accelerators, being present in an amount ranging from about 0.5 wt. % to about 5 wt. %;
h. the plasticizer is present in an amount in a range of 20-50 wt. %;
i. the filler is present in an amount in a range of 1 to 20 wt. %;
j. the antioxidant, having a melting point greater than 130° C., is present in a range of 0.5-1.5 wt. %;
wherein the peroxide curing agent and the co-crosslinking agent are present in an amount of 0.1 to 2 wt. %, the liquid rubber is functionalized with maleic anhydride, optionally comprising an amount of 0.1 to 30% maleic anhydride functional groups, and the composition is curable in about 15-20 minutes at a metal temperature of 140° C.

13. The composition of claim 11, wherein the blowing agent is selected from OBSH, ADCA or a combination thereof, optionally including an accelerator package.

14. The composition of claim 11, wherein the blowing agent comprises OBSH.

15. An article of manufacture comprising: a part having a metal surface, a composite material surface or a combination of said surfaces; and deposited on a portion of said surfaces, an uncured, heat expandable sealant comprising: SBR rubber; a PVC homopolymer/copolymer and/or acrylic resin; an amide wax; a blowing agent; a liquid rubber functionalized with maleic anhydride, epoxy or acid function groups; vulcanizing agent, comprising sulfur; one or more vulcanization accelerators, and at least one filler; wherein the sealant is curable within a target bake condition of 15 minutes at 140° C. metal temperature to exhibit a cohesive failure mode of at least 80%.

16. The article of manufacture of claim 15, wherein the uncured, heat expandable sealant deposited on said surfaces exhibits less than 10% increase in height after a 24 hour inverted dwell time.

17. The article of manufacture of claim 15, wherein the uncured, heat expandable sealant is capable of a vertical height expansion, at 15 minutes bake at 140° C., of greater than 8 times (8×) the uncured heat expandable sealant as deposited.

18. The article of manufacture of claim 15, wherein the article is an aerospace, automotive, marine, or construction vehicle part.

19. A method for producing an article, the method comprising:
a) applying a pumpable thermally expandable sealant composition according to claim 1 into a gap in the article; and
b) heating the article comprising the pumpable thermally expandable sealant composition to a temperature above an activation temperature of the blowing agent to form an expanded material within the gap in the article thereby producing a reinforced and/or sealed section of the gap in the article.

20. The method of claim 19, wherein the article is a vehicle part.
